(19) United States
(12) Patent Application Publication
(10) Pub. No.: US 2015/0203089 A1
(43) Pub. Date: Jul. 23, 2015

(54) AIR-THRUST VEHICLE

(71) Applicant: MAHAJAN MAHESH DATTATRAY, Karnataka (IN)

(72) Inventor: Mahesh Dattatray Mahajan, Karnataka (IN)

(21) Appl. No.: 14/430,779

(22) PCT Filed: Sep. 19, 2013
(86) PCT No.: PCT/IN2013/000566

§ 371 Date: Mar. 24, 2015

(30) Foreign Application Priority Data
Sep. 26, 2012 (IN) 3988/CHE/2012

(51) Int. Cl. B60V 1/15; B60V 1/18

(52) U.S. Cl. CPC B60V 1/15; B60V 1/18

(57) ABSTRACT

An air-thrust vehicle (100) includes a base (130) and an inverted saucer shaped body (132) mounted on the base (130). A plurality of sets of apertures (114, 115, 116, 117, 118, 119, 120, 121) is defined at a plurality of pre-determined locations on the base (130) and the saucer shaped body (132). A plurality of air-displacement mechanisms (105) is configured to draw air via pre-determined sets of apertures and force air via other pre-determined sets of apertures for providing lift for forward and backward movement and for providing horizontal pivoting of the vehicle (100) on the base. A plurality of ducts (122) is adapted to operatively connect the air-displacement mechanisms (105) to each aperture of the sets of apertures (114, 115, 116, 117, 118, 119, 120, 121) and an engine (106) is coupled to operate the air-displacement mechanisms (105).

### FIELD OF THE DISCLOSURE

The present disclosure relates to the field of airborne vehicles.

### BACKGROUND

Presently, roadways are extensively used for transportation of goods as well as for commuting by people. This is because roadways provide a cost effective method of transportation over other modes of transportation. Hence, over the past few years, there has been a continuous increase in the number of vehicles plying on roads. As a result, roads are becoming increasingly congested. Road congestion causes wastage of valuable time. Further, fuel consumption of land vehicles increases during congestion, thereby increasing operational cost of the land vehicles and also causes environmental pollution.

In order to overcome the problems associated with roadways, alternate mode of transportation by air has been developed with the advent of airplanes. However, commuting by airplanes involve high cost and requires specific location for landing and take-off. Further, airplanes are operated on fossil fuel which causes environmental pollution.

There is thus felt a need for eliminating the problems associated with the presently available modes of transportation.

### OBJECTS

Some of the objects of the present disclosure which at least one embodiment is adapted to provide, are described herein below:

An object of the present disclosure is to provide an air-thrust vehicle having a low production cost.

Another object of the present disclosure is to provide an air-thrust vehicle that does not require wings to fly.

Still another object of the present disclosure is to provide an air-thrust vehicle that can operate on any category of airfield.

Yet another object of the present disclosure is to provide an air-thrust vehicle that is easy to drive.

Still a further object of the present disclosure is to provide an air-thrust vehicle with reduced operational cost.

Other objects and advantages of the present disclosure will be apparent from the following description when read in conjunction with the accompanying figures, which are not intended to limit the scope of the present disclosure.

### SUMMARY

In accordance with an embodiment of the present disclosure, there is provided an air-thrust vehicle. The air-thrust vehicle includes
a base;
an inverted saucer shaped body mounted on the base;
a plurality of sets of apertures defined at a plurality of pre-determined locations on the base and a plurality of sets of apertures defined at a plurality of pre-determined locations on the saucer shaped body;
a plurality of air-displacement mechanisms configured to draw air via pre-determined sets of apertures and force air through other pre-determined sets of apertures for providing lift for forward and backward movement and for providing horizontal pivoting of the vehicle on the base;
a plurality of ducts adapted to operatively connect the air-displacement mechanisms to each aperture of the sets of apertures; and
an engine coupled to operate the air-displacement mechanism.

Typically, the plurality of pre-determined locations are selected from the group consisting of front side, upper side, back side, front left side, rear left side, front right side, rear right side and bottom side.

The air-displacement mechanism is selected from the group consisting of an axial compressor, a booster, a blower and a gas turbine.

Typically, the air-displacement mechanism is configured to draw air via set of apertures defined at said upper side and force air via set of apertures defined at the bottom side for providing the lift to the air-thrust vehicle.

Typically, the air-displacement mechanism is configured to draw air via set of apertures defined at said front side and force air via set of apertures defined at the back side for providing the forward movement to the air-thrust vehicle.

Typically, the air-displacement mechanism is configured to draw air via set of apertures defined at the front left side and force air via set of apertures defined at the rear left side for turning the air-thrust vehicle in operative left direction.

Additionally, the air-displacement mechanism is further configured to draw air via sets of apertures defined at the front left side and the rear right side of the air-thrust vehicle and force the air via sets of apertures defined at the front right side and the rear left side for turning the air-thrust vehicle in operative left direction.

Typically, the air-displacement mechanism is further configured to draw air via set of apertures defined at the front right side and force air via set of apertures defined at the rear right side for turning the air-thrust vehicle in operative right direction.

Additionally, the air-displacement mechanism is configured to draw air via sets of apertures defined at the front right side and the rear left side of the air-thrust vehicle- and force air via sets of apertures defined at the front left side and the rear right side for turning the air-thrust vehicle in operative right direction.

Typically, the air-displacement mechanism is configured to draw air via sets of apertures defined at the front left side and the rear left side of the air-thrust vehicle and force the air via sets of apertures defined at the front right side and the rear right side for moving the air-thrust vehicle in operative left direction.

Typically, the air-displacement mechanism is configured to draw air via sets of apertures defined at the front right side and the rear right side of the air-thrust vehicle and force air via sets of apertures defined at the front left side and the rear left side for moving the air-thrust vehicle in operative right direction.

Typically, the air-displacement mechanism is configured to draw air via set of apertures defined at the back side and force air via set of apertures defined at the front side for providing the backward movement to the air-thrust vehicle.

Typically, the sets of apertures are provided with an air filter.

Further, the air-thrust vehicle includes a rubber coating covering at least a portion of the body and the base.

In accordance with another embodiment of the present disclosure, the air-thrust vehicle further includes a window glass disposed on at least a portion of the body.

Typically, the air-thrust vehicle is having a centre of gravity located at the centre point of the base.

Additionally, the air-thrust vehicle may be adapted to accommodate at least one passenger,

### BRIEF DESCRIPTION OF THE ACCOMPANYING DRAWINGS

The disclosure will now be described with the help of the accompanying drawings, in which:

FIG. 1A illustrates a side view of an air-thrust vehicle depicting the air-displacement mechanism providing lift for upward movement of the air-thrust vehicle in accordance with an embodiment of the present disclosure;

FIG. 1B illustrates a perspective side view of the air-thrust vehicle depicting the air-displacement mechanism providing lift for upward movement of the air-thrust vehicle of FIG. 1A;

FIG. 1C illustrates a bottom view of the air-thrust vehicle depicting the air-displacement mechanism providing lift for upward movement of the air-thrust vehicle of FIG. 1A;

FIG. 2A illustrates the side view of the air-thrust vehicle depicting the air-displacement mechanism providing thrust for forward movement of the air-thrust vehicle of FIG. 1A;

FIG. 2B illustrates a front view of the air-thrust vehicle depicting the air-displacement mechanism providing thrust for forward movement of the air-thrust vehicle of FIG. 1A;

FIG. 2C illustrates a back view of the air-thrust vehicle depicting the air-displacement mechanism providing thrust for forward movement of the air-thrust vehicle of FIG. 1A;

FIG. 3A illustrates the side view of the air-thrust vehicle depicting the air-displacement mechanism providing thrust for turning the air-thrust vehicle in an operative left direction;

FIG. 3B illustrates a top view of the air-thrust vehicle depicting the air-displacement mechanism providing thrust for turning the air-thrust vehicle in the operative left direction;

FIG. 3C illustrates the top view of the air-thrust vehicle depicting the air-displacement mechanism providing thrust for turning the air-thrust vehicle in the operative left direction;

FIG. 4A illustrates the side view of the air-thrust vehicle depicting the air-displacement mechanism providing thrust for turning the air-thrust vehicle in an operative right direction;

FIG. 4B illustrates the top view of the air-thrust vehicle depicting the air-displacement mechanism providing thrust for turning the air-thrust vehicle in the operative right direction;

FIG. 4C illustrates the top view of the air-thrust vehicle depicting the air-displacement mechanism providing thrust for turning the air-thrust vehicle in the operative right direction;

FIG. 5A illustrates the side view of the air-thrust vehicle depicting the air-displacement mechanism providing thrust for the movement of the air-thrust vehicle in the operative left direction;

FIG. 5B illustrates the top view of the air-thrust vehicle depicting the air-displacement mechanism providing thrust for the movement of the air-thrust vehicle in the operative left direction;

FIG. 6A illustrates the side view of the air-thrust vehicle depicting the air-displacement mechanism providing thrust for the movement of the air-thrust vehicle in the operative right direction;

FIG. 6B illustrates the top view of the air-thrust vehicle depicting the air-displacement mechanism providing thrust for the movement of the air-thrust vehicle in the operative right direction;

FIG. 7A illustrates the side view of the air-thrust vehicle depicting the air-displacement mechanism providing thrust for the backward movement of the air-thrust vehicle of FIG. 1A;

FIG. 7B illustrates the front view of the air-thrust vehicle depicting the air-displacement mechanism providing thrust for the backward movement of the air-thrust vehicle of FIG. 1A;

FIG. 7C illustrates the back view of the air-thrust vehicle depicting the air-displacement mechanism providing thrust for the backward movement of the air-thrust vehicle of FIG. 1A;

FIG. 8A illustrates a perspective front view of the air-thrust vehicle depicting the disposition of air filters on a plurality of apertures defined on the air-thrust vehicle of FIG. 1A;

FIG. 8B illustrates a back view of the air-thrust vehicle depicting the disposition of air filters on a plurality of apertures defined on the air-thrust vehicle of FIG. 1A;

FIG. 9A illustrates a perspective side view of the air-thrust vehicle depicting a rubber coating on a body and base of the air-thrust vehicle of FIG. 1A;

FIG. 9B illustrates a bottom view of the air-thrust vehicle depicting the rubber coating on the base of the air-thrust vehicle of FIG. 1A;

FIG. 10A illustrates the side view of the air-thrust vehicle depicting the arrangement of the window glass on the body of the air-thrust vehicle of FIG. 1A;

FIG. 10B illustrates the bottom view of the air-thrust vehicle depicting the arrangement of the window glass on the base of the air-thrust vehicle of FIG. 1A;

FIG. 11A illustrates the side view of the air-thrust vehicle depicting the position of center of gravity of the air-thrust vehicle of FIG. 1A;

FIG. 11B illustrates the bottom view of the air-thrust vehicle depicting the position of center of gravity of the air-thrust vehicle of FIG. 1A;

FIG. 12A illustrates the seating arrangement for the passengers inside the air-thrust vehicle in accordance with an embodiment of the present disclosure;

FIG. 12B illustrates the seating arrangement for the passengers inside the air-thrust vehicle in accordance with another embodiment of the present disclosure;

FIG. 13A illustrates the perspective side view of the air-thrust vehicle depicting the comprehensive structure of the air-thrust vehicle of FIG. 1A;

FIG. 13B illustrates the top view of the air-thrust vehicle depicting the comprehensive structure of the air-thrust vehicle of FIG. 1A;

FIG. 14 illustrates a diagram of the air-displacement mechanism utilized by the air-thrust vehicle of FIG. 1A;

FIG. 15A illustrates a schematic diagram of the air-thrust vehicle depicting the connection of the air-displacement mechanism with the plurality of apertures; and

FIG. 15B illustrates the bottom view of the air-thrust vehicle depicting the connection of the air-displacement mechanism with an engine;

### DETAILED DESCRIPTION

The air-thrust vehicle of the present disclosure will now be described with reference to the embodiments which do not limit the scope and ambit of the disclosure. The description relates purely to the exemplary preferred embodiments of the disclosed system and its suggested applications.

The system herein and the various features and advantageous details thereof are explained with reference to the non-limiting embodiments in the following description.

Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The air-thrust vehicle as envisaged by the present disclosure is basically an air vehicle capable to fly in the air based on the thrust generated by the forced displacement of the air in a particular direction. The plurality of air-displacement mechanism is utilized to draw and expel air via plurality of apertures to provide lift for the movement of the air-thrust vehicle.

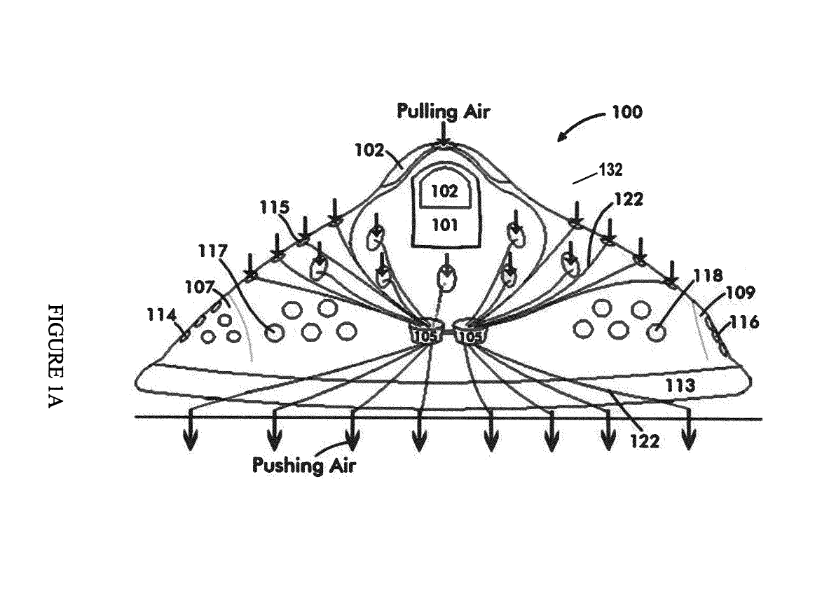

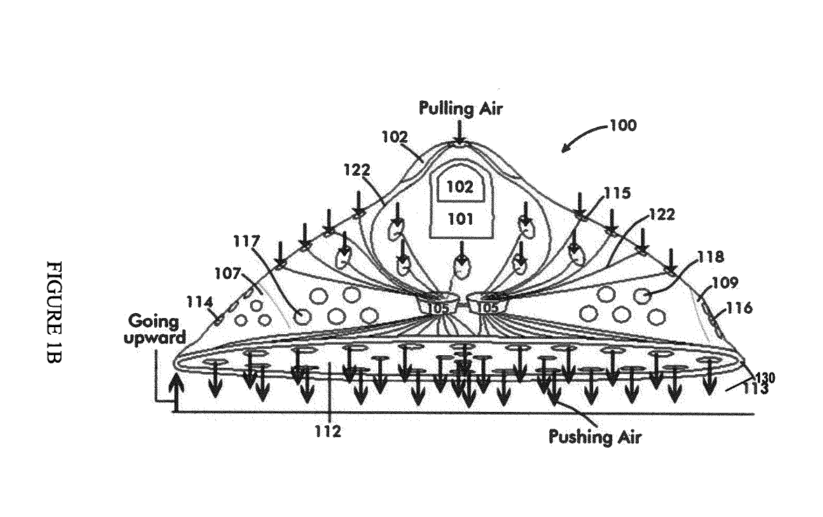

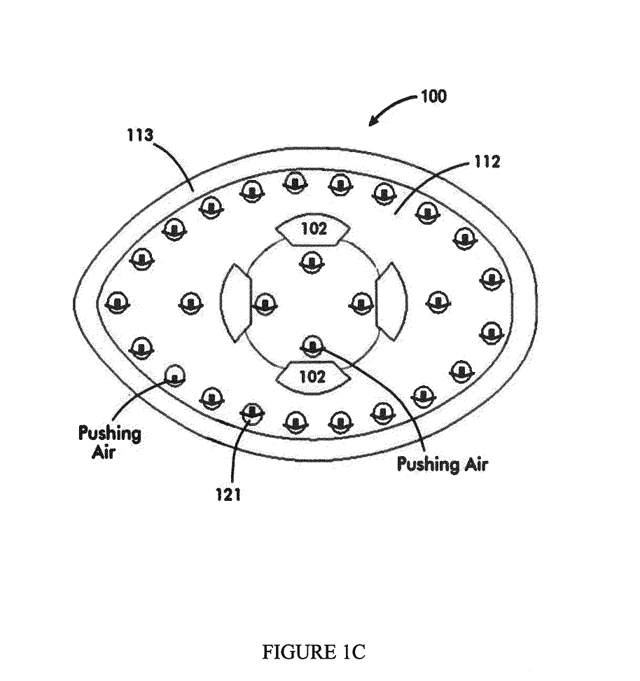

The air-thrust vehicle of the present disclosure will now be explained with reference to FIG. 1A through FIG. 15B with key components referenced generally as illustrated in the figures.

The air-thrust vehicle 100 includes a saucer shaped body 132 mounted on a base 130. The air-thrust vehicle 100 further includes a plurality of sets of apertures defined at a plurality of locations on the body 132, wherein a set of apertures 114 is defined on a front side portion 107, a set of apertures 115 is defined on an upper side portion 108, a set of apertures 116 is defined on a back side portion 109, sets of apertures 117 and 118 are defined on a left side portion 110, and sets of apertures 119 and 120 are defined on a right side portion 111 of the body 132. Further, a set of apertures 121 is defined on a bottom side 112 of the base 130.

The air-thrust vehicle 100 includes a plurality of air-displacement mechanism 105 disposed within the body 132 and is operatively connected to the plurality of sets of apertures via a plurality of ducts 122. Typically, the air-displacement mechanism is a blower. The air-displacement mechanism is not limited to a blower and an axial. compressor, a booster and a gas turbine may be used for the displacement of air.

The air-displacement mechanism 105 is used to generate lift for the upward and backward movement of the air-thrust vehicle 100 and the horizontal pivoting of the air-thrust vehicle 100 on the base 130.

FIGS. 1A, 1B and 1C illustrate an upward movement of the air-thrust vehicle 100 due to the lift generated by the air-displacement mechanism 105. As shown in FIG. 1A, the air-displacement mechanism 105 draws air from the set of apertures 115 via the plurality of ducts 122 and force the air through the set of apertures 121 via the plurality of ducts 122. Due to forced pushing of the air through the set of apertures 121 defined on the bottom side 112 of the base 130 (as shown in FIGS. 1B and 1C), a force of equal magnitude but opposite in direction acts on the bottom side 112 of the base 130, thereby lifting the vehicle in an upward direction.

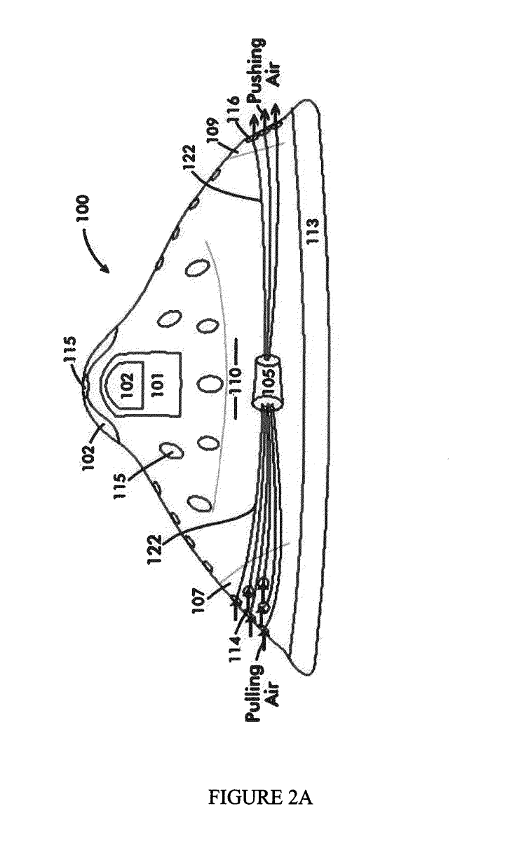

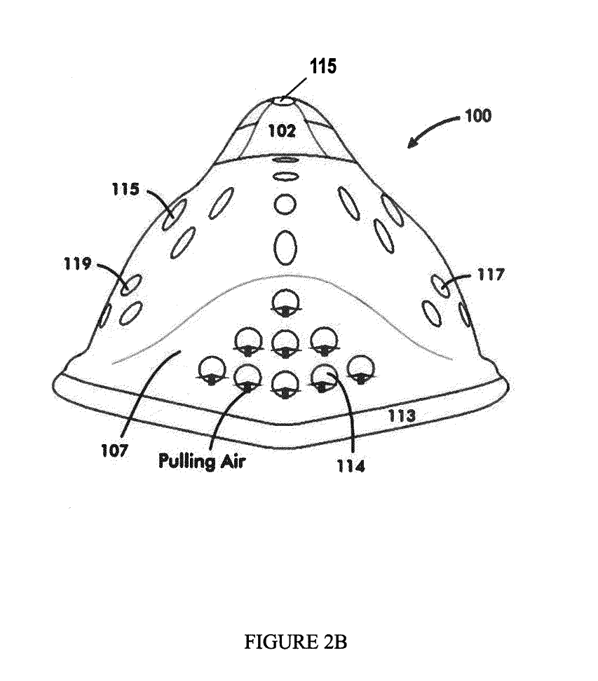

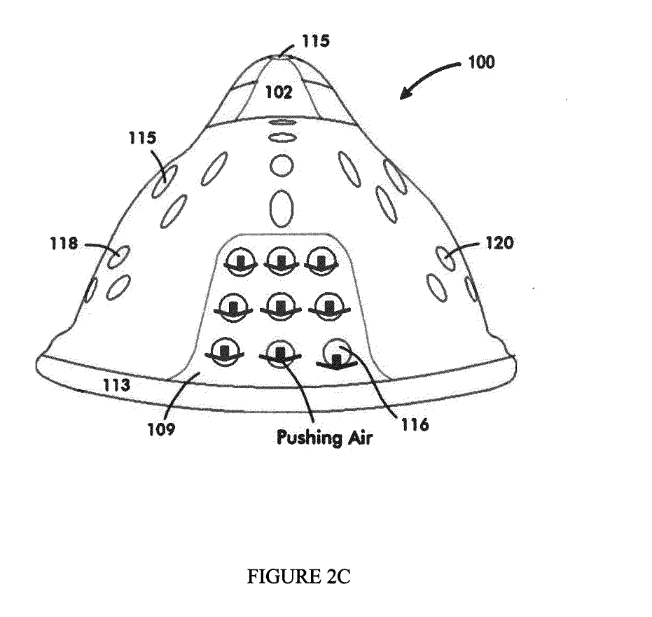

FIGS. 2A, 2B and 2C illustrate a forward movement of the air-thrust vehicle 100 due to thrust developed by the air-displacement mechanism 105. As shown in FIGS. 2A and 2B, the air-displacement mechanism 105 draws air from the set of apertures 114 via the plurality of ducts 122 and force the air through the set of apertures 116 via the plurality of ducts 122. Due to pushing of air through the set of apertures 116 defined on the back side portion 109 of the body 132 (as shown in FIG. 2C), a reaction force acts on the back side portion 109 of the air-thrust vehicle 100, thereby providing a movement to the air-thrust vehicle 100 in a forward direction.

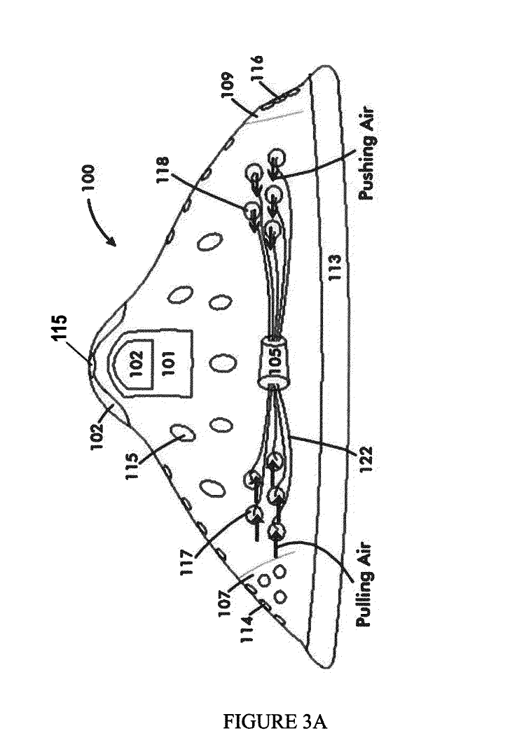

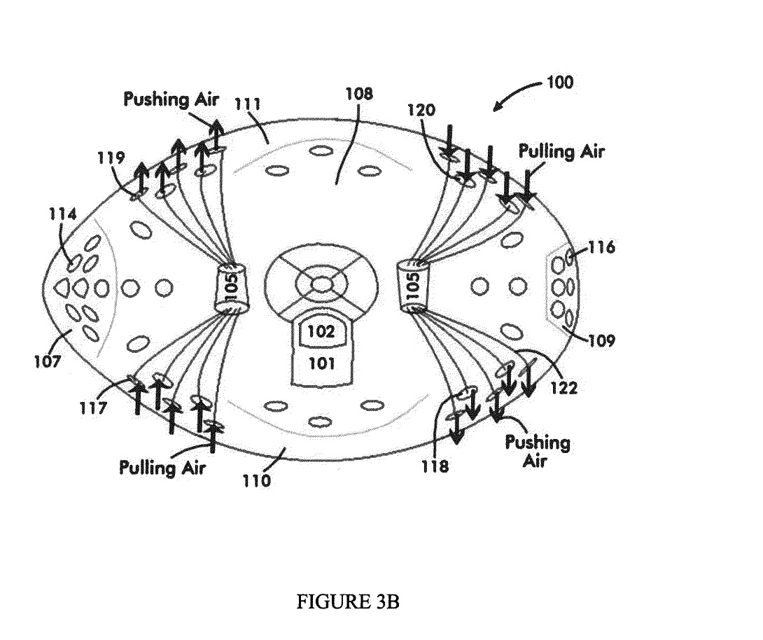

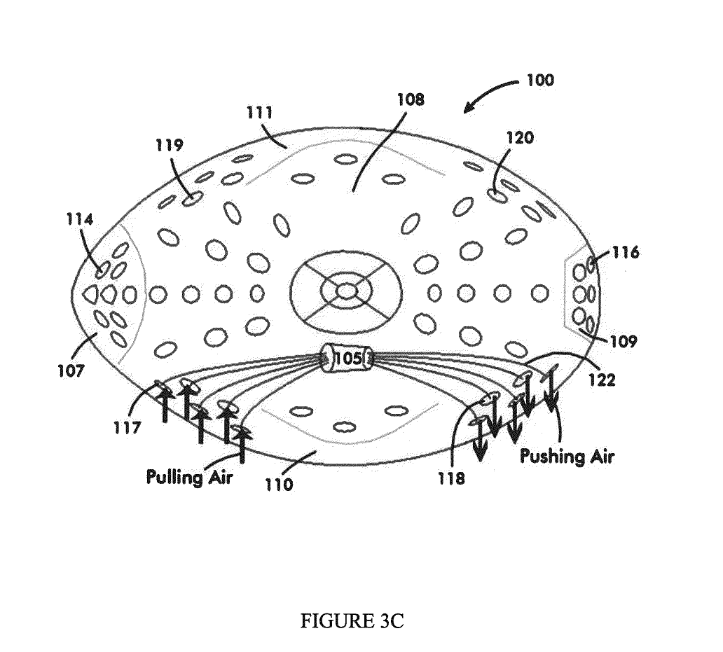

FIGS. 3A, 3B and 3C illustrate a turning movement of the air-thrust vehicle 100 in the operative left direction. In accordance with one embodiment of the present disclosure, the air-displacement mechanism 105 draws air from the set of apertures 117 defined at the front position of the left side portion 110 and force the air from the set of apertures 118 defined at the rear position of the left side portion 110 (as shown in FIGS. 3A & 3C), thereby providing a force for turning the air-thrust vehicle 100 in the operative left direction. In accordance with another embodiment of the present disclosure, the air-displacement mechanism 105 draws air from the set of apertures 117 defined at the front position of the left side portion 110 and the set of apertures 120 defined at the rear position of the right side portion 111(as shown in FIG. 3B).

The air-displacement mechanism 105 force the air through the set of apertures 119 defined at the front position of the right side portion 111 and through the set of apertures 118 defined at the left side portion 110. Due to pushing of the air through the above mentioned set of apertures, a thrust acts on the front position of the right side portion 111 and the rear position of the left side portion 110, thereby turning the air-thrust vehicle in the operative left direction.

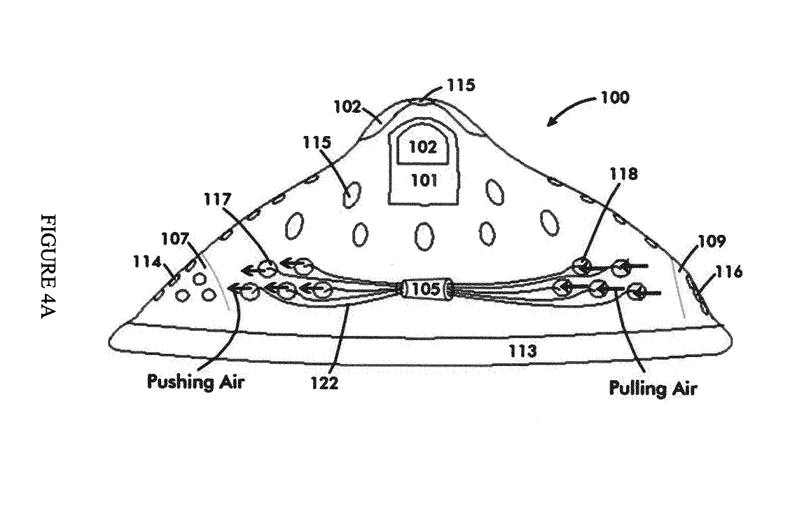

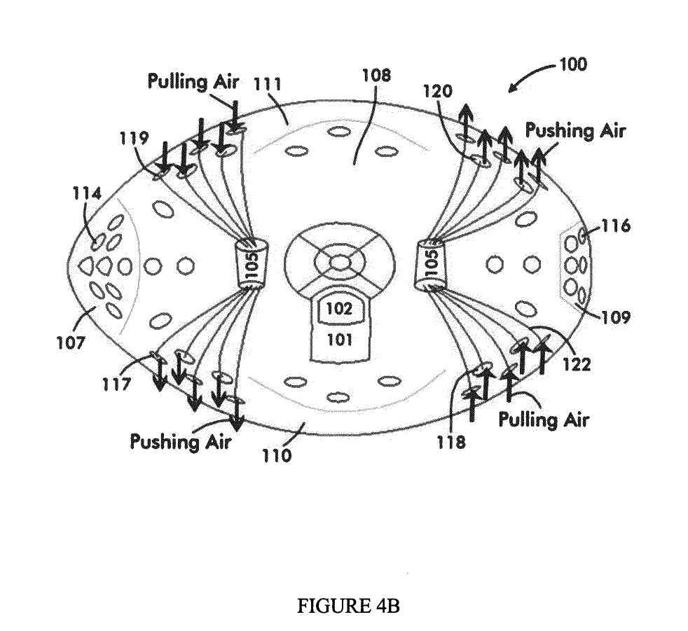

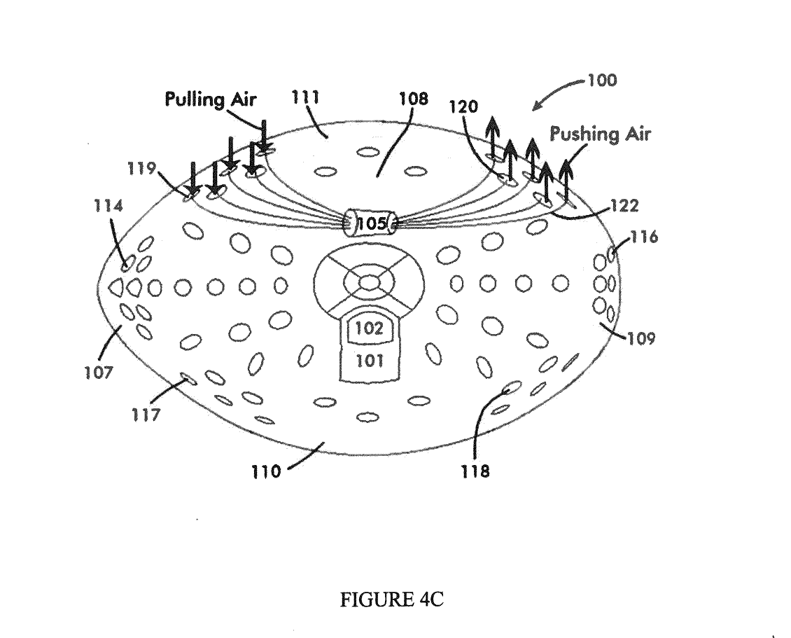

FIGS. 4A, 4B and 4C illustrate the turning movement of the air-thrust vehicle 100 in the operative right direction. In accordance with one embodiment of the present disclosure (as shown in FIG. 4A), the air-displacement mechanism 105 draws air from the set of apertures 118 and force the air through the set of apertures 117 for turning the air-thrust vehicle 100 in the operative right direction. In accordance with another embodiment of the present disclosure (as shown in FIG. 4C), the air-displacement mechanism 105 draws air from the set of apertures 119 and force the air through the set of apertures 120 for turning the air-thrust vehicle 100 in the operative right direction.

In accordance with another embodiment of the present disclosure (as shown in FIG. 4B), the air-displacement mechanism 105 draws air from the set of apertures 119 and the set of apertures 118 and force the air through the set of apertures 117 and the set of apertures 120. Due to forcing of the air through the aforementioned set of apertures, an equal and opposite force acts on the rear position of the right side portion 111 and the front position of the left side portion 110, thereby turning the air-thrust vehicle 100 in the operative right direction.

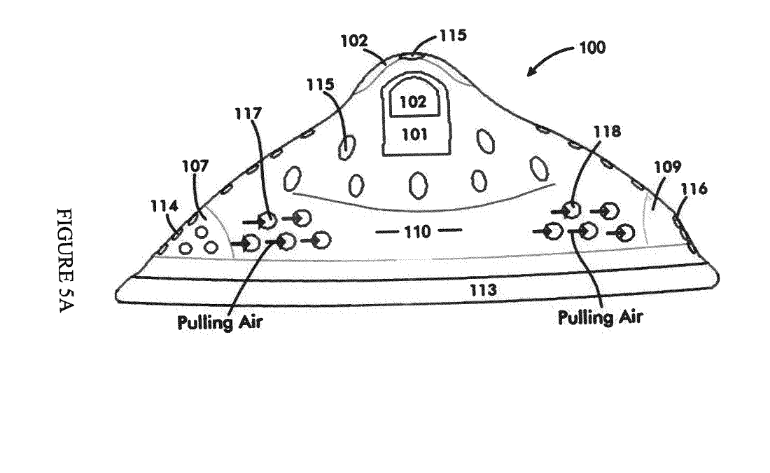

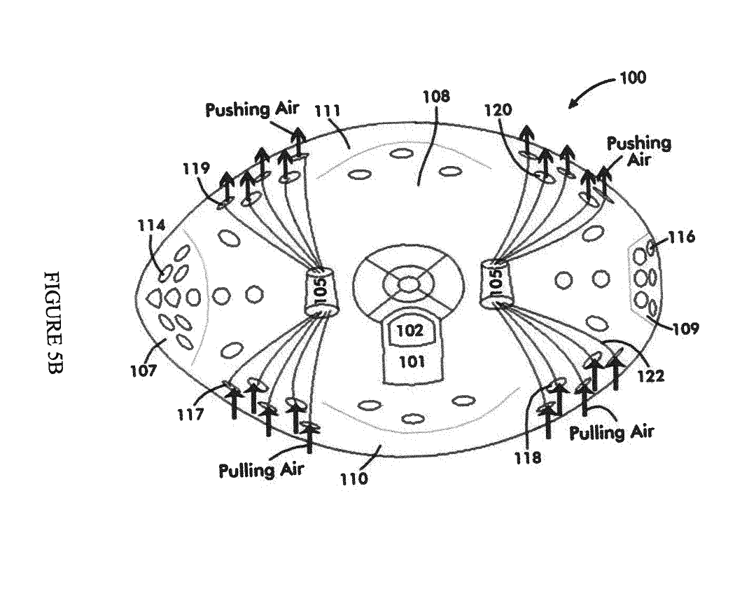

FIGS. 5A and FIG. 5B illustrate the movement of the air-thrust vehicle 100 in the operative left direction. The air-displacement mechanism 105 draws air from the set of apertures 117 and the set of apertures 118 and force the drawn air through the set of apertures 119 and the set of apertures 120, thereby generating the thrust that enables the movement of the air-thrust vehicle 100 in the operative left direction.

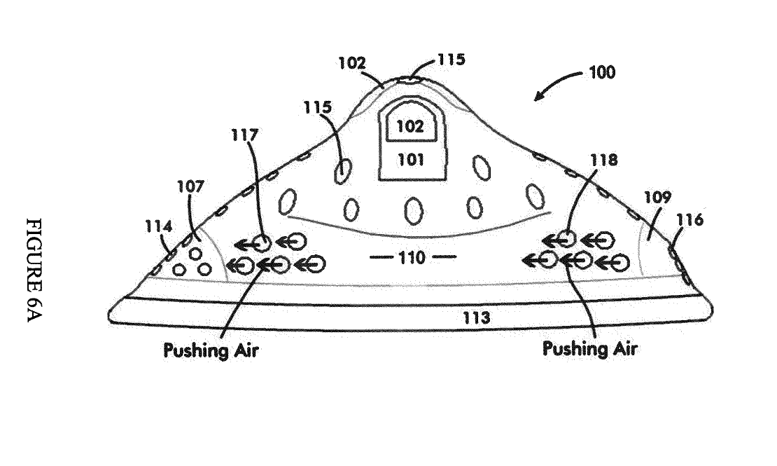

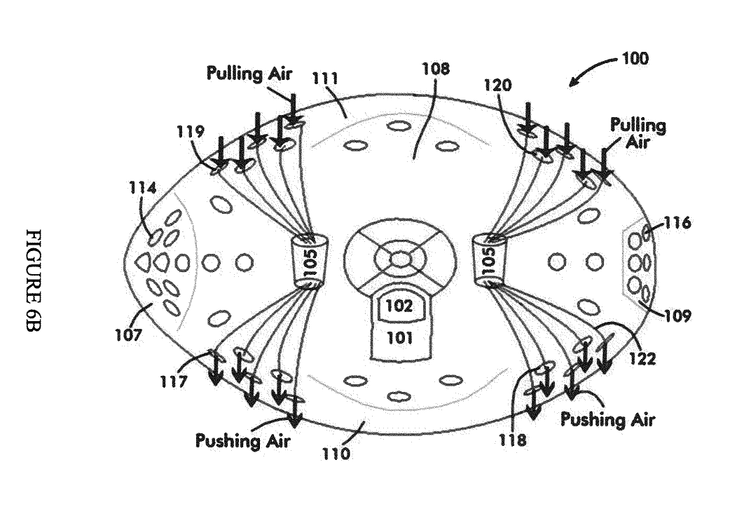

FIG. 6A and FIG. 6B illustrate the movement of the air-thrust vehicle 100 in the operative right direction. The air-displacement mechanism 105 draws air from the set of apertures 119 and the set of apertures 120 and force the drawn air through the set of apertures 117 and the set of apertures 118, thereby generating the thrust that enables the movement of the air-thrust vehicle 100 in the operative right direction.

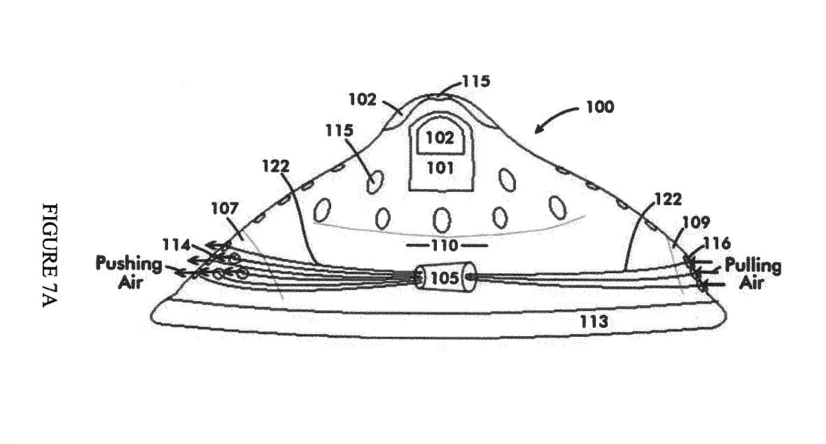

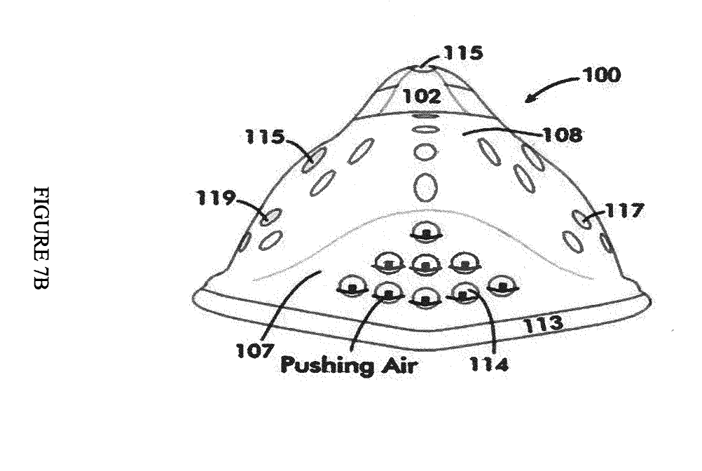

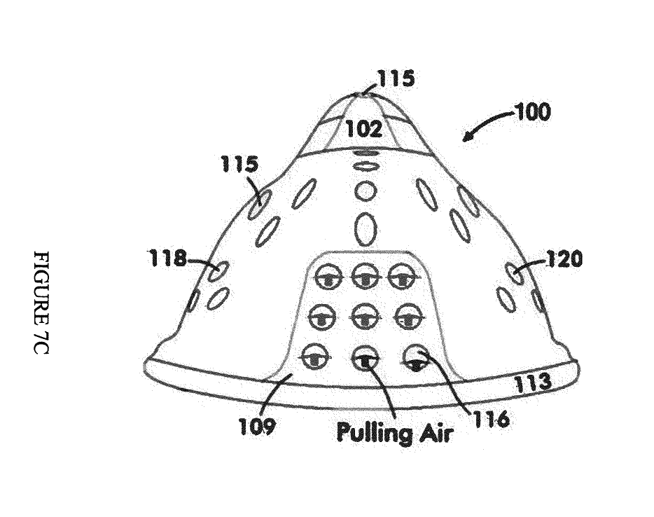

FIGS. 7A, 7B and 7C illustrate the backward movement of the air-thrust vehicle 100. As shown in FIG. 7A, the air-displacement mechanism 105 draws air from the set of apertures 116 via the plurality of ducts 122 and force the air through the set of apertures 114 via the plurality of ducts 122. Due to pushing of air through the set of apertures 114 defined on the front side portion 107 of the body 132 (as shown in FIGS. 7C and 7B), a reaction force acts on the front side portion 107 of the air-thrust vehicle 100, thereby moving the air-thrust vehicle 100 backward.

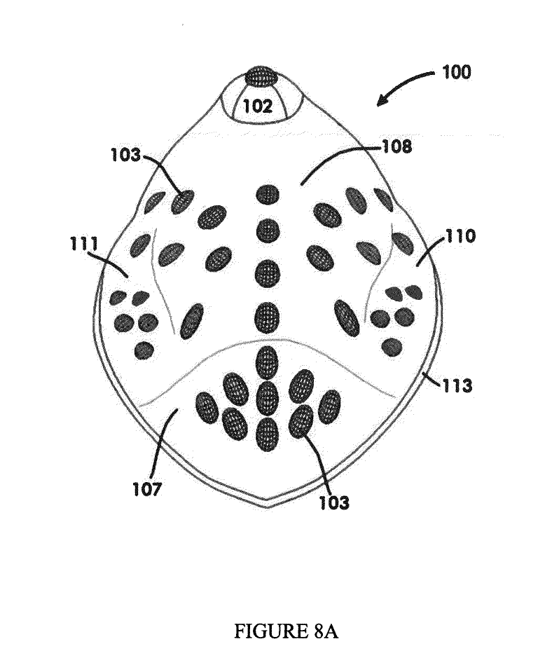

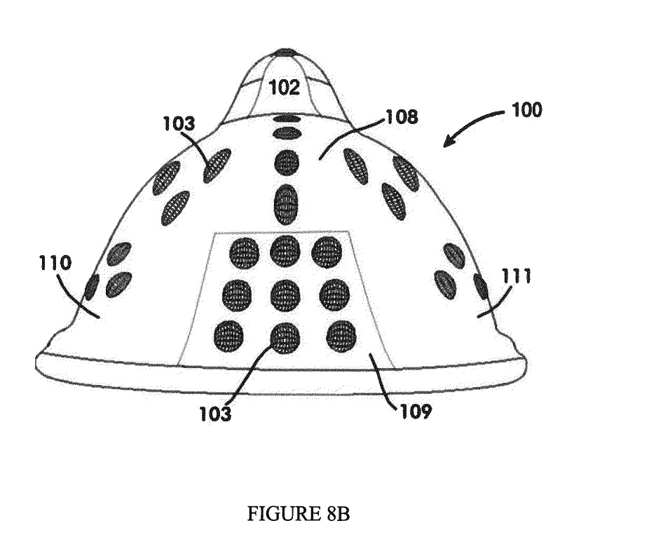

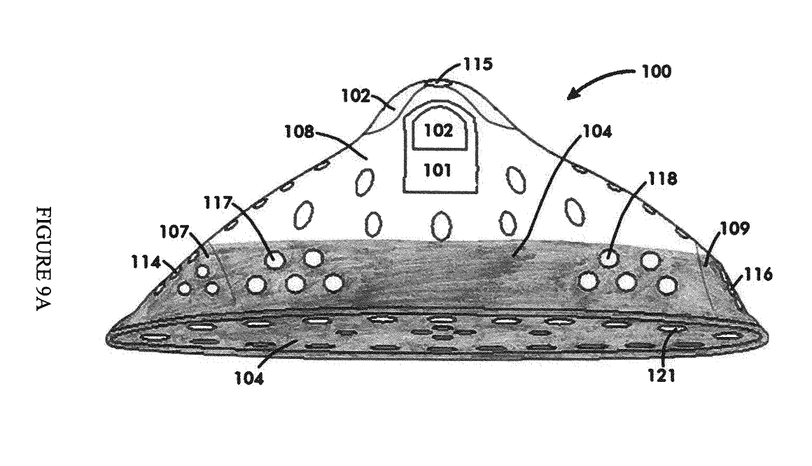

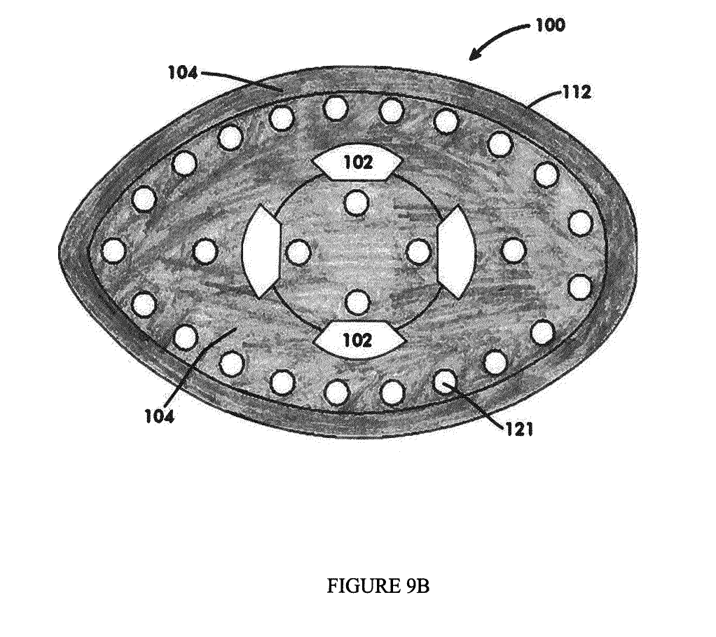

In accordance with an embodiment of the present disclosure, the apertures are provided with an air filter 103, typically a net cap (as shown in FIG. 8A and FIG. 8B) for prohibiting the suction of air-bags, papers and other waste products by the air-displacement mechanism 105. In accordance with another embodiment of the present disclosure, a rubber coating is provided on the bottom side 112 of the base 130 and on the surrounding lower portion of the body 132 of the air-thrust vehicle 100 (as shown in FIGS. 9A and 9B) for protecting the air-thrust vehicle 100 from electric currents in case it comes into contact of any electric pole and to prevent the body 132 to come into contact of any object present on the earth surface.

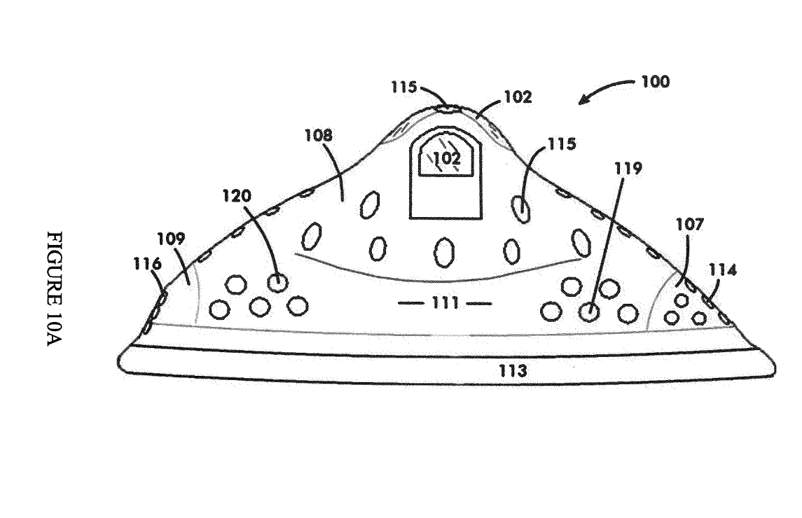

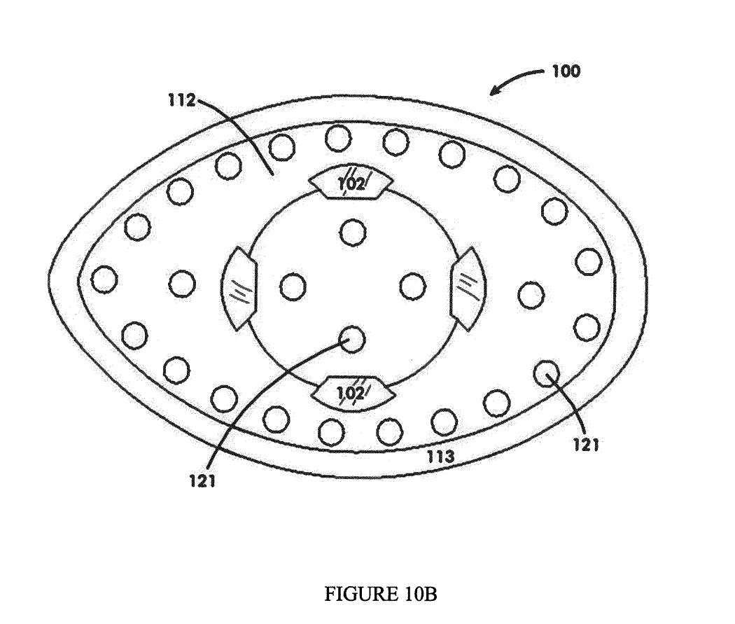

In accordance with another embodiment of the present disclosure, the air-thrust vehicle 100 comprises a window glass 102 (as shown in FIGS. 10A and 10B) disposed on the body 132 and on the bottom side 112 of the base 130. The window glass 102 is typically used for enabling the user to get the view of ground and surroundings. Further, the window glass 102 is provided to protect occupants of the vehicle from wind and flying debris such as dust, insects, and rocks.

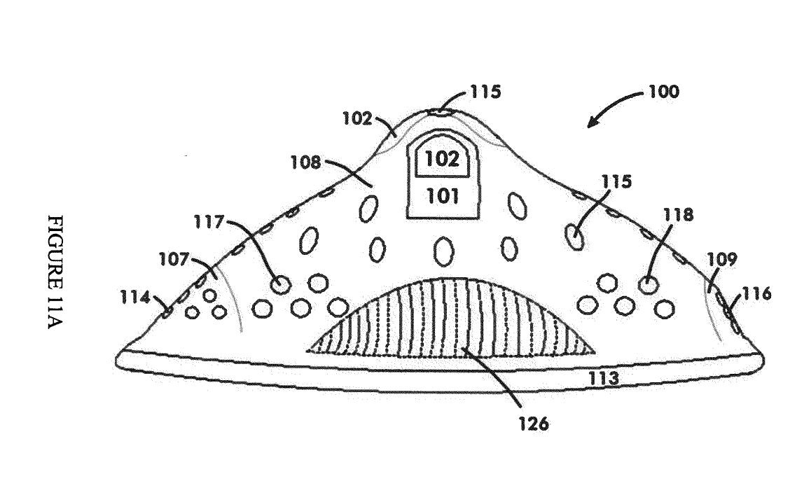

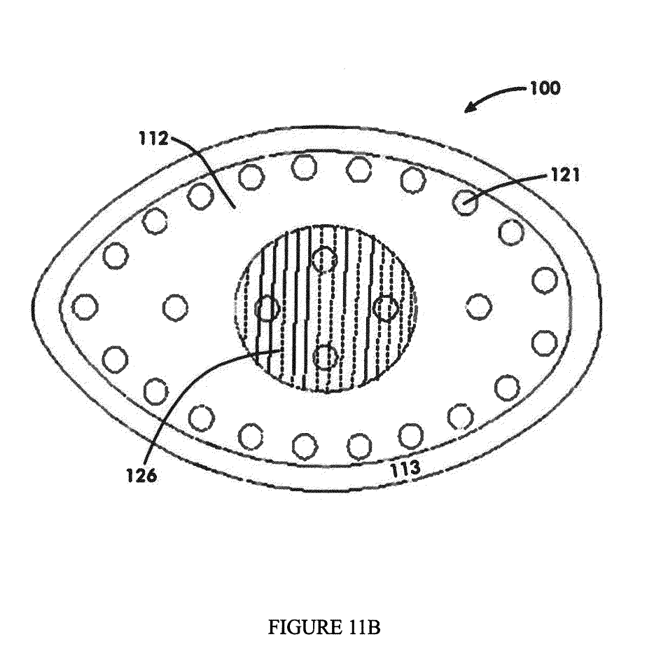

In accordance with another embodiment of the present disclosure, the center of gravity of the air-thrust vehicle 100 is located at the center point 126 of the base 130 (as shown in FIGS. 11A and 11B) for providing the appropriate balance to the air-thrust vehicle 100 during the flight.

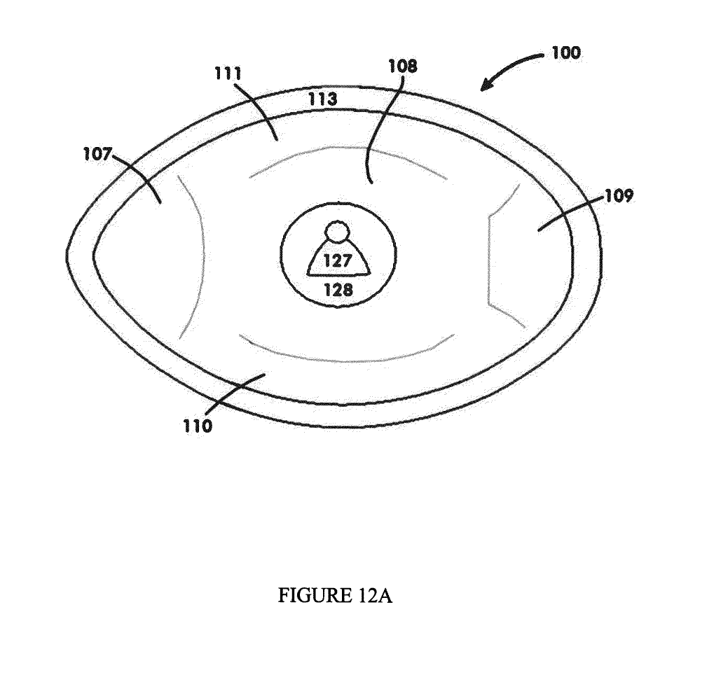

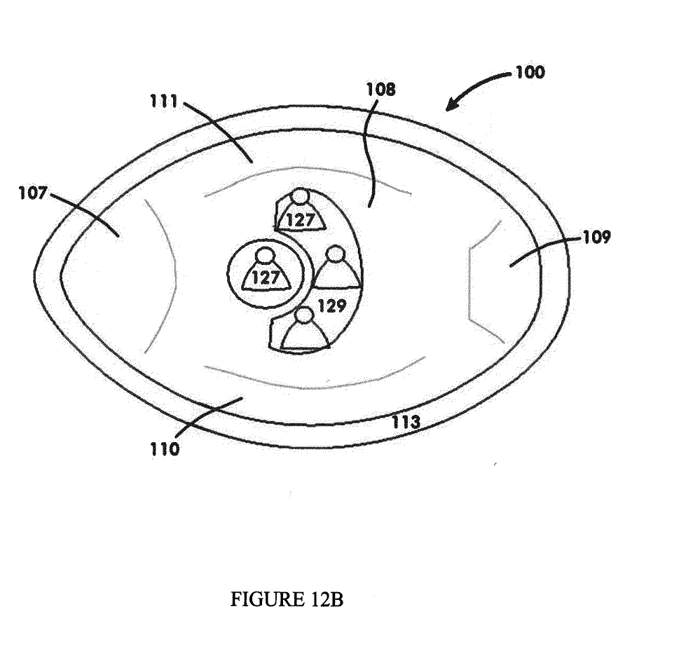

In accordance with another embodiment of the present disclosure, the air-thrust vehicle has a seating arrangement 129 for facilitating the seating of at least one passenger 127 (as shown in FIGS. 12A and 12B).

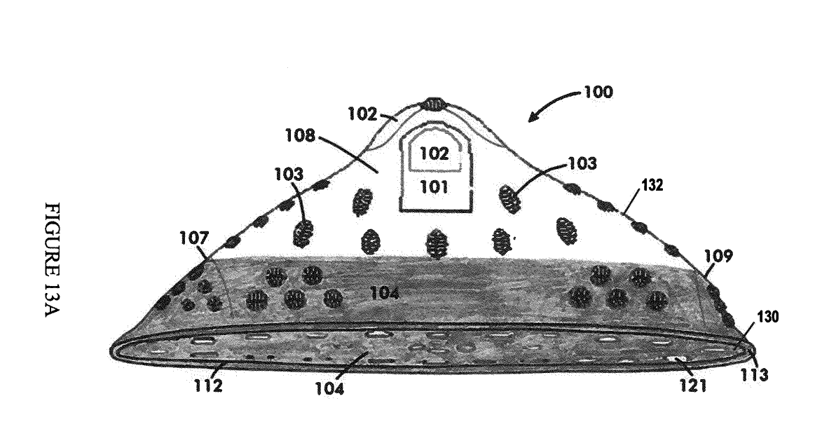

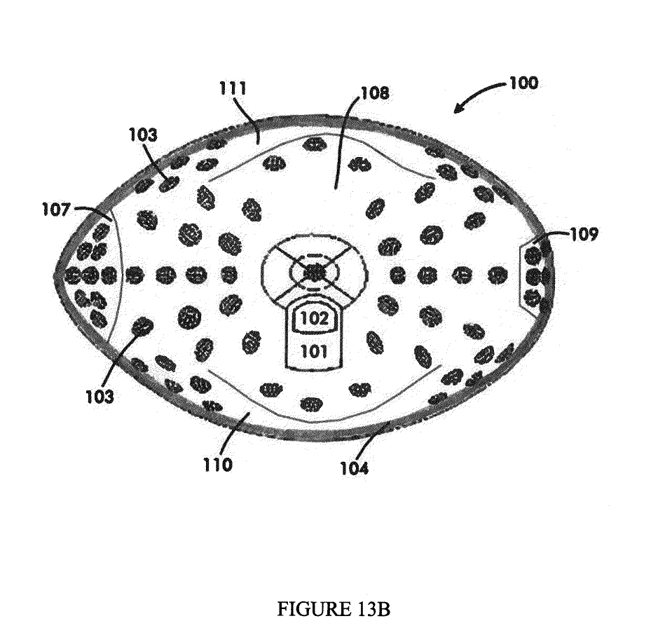

FIG. 13A and FIG. 13B illustrate the comprehensive outer structure of the air-thrust vehicle 100 depicting the arrangement of net caps 103 on the apertures defined on the body 132 and the base 130, rubber coating on the body 132 and the base 130, a bumper 113 and disposition of a door 101 on the body 132 of the air-thrust vehicle 100.

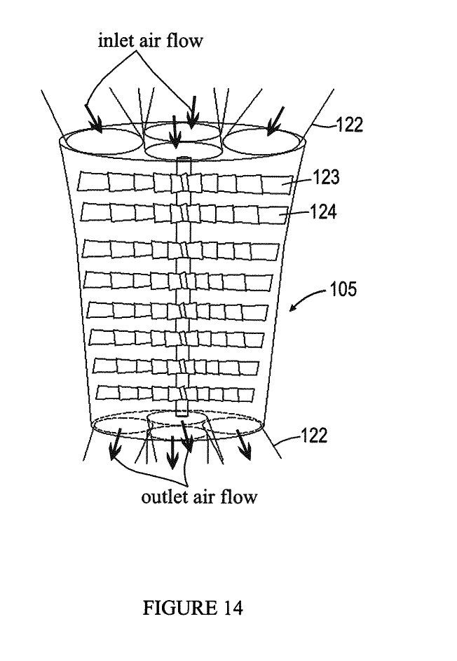

FIG. 14 illustrates a diagram of the air-displacement mechanism 105 utilized by the air-thrust vehicle 100. The air-displacement mechanism 105 includes the rotatory and stationary components, typically rotor blades 123 and the stator blades 124. The plurality of ducts 122 are connected to the air-displacement mechanism 105 at both the ends for facilitating the inlet and outlet of air flow.

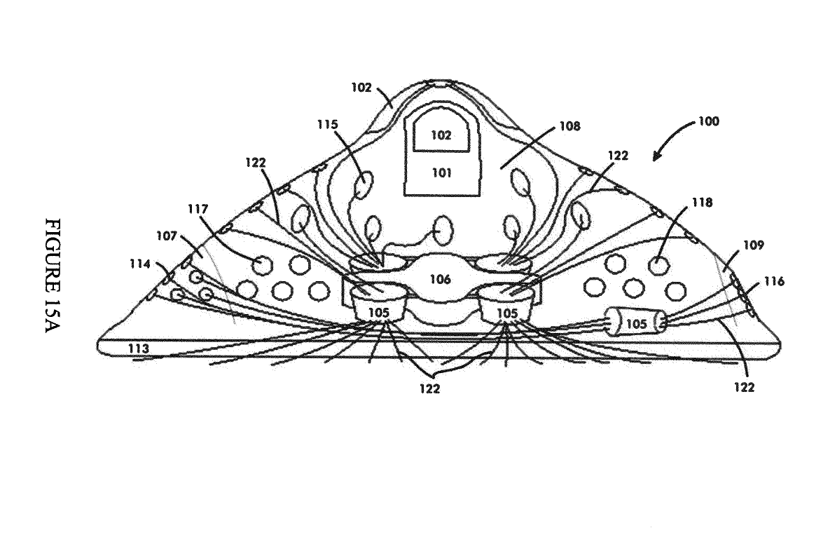

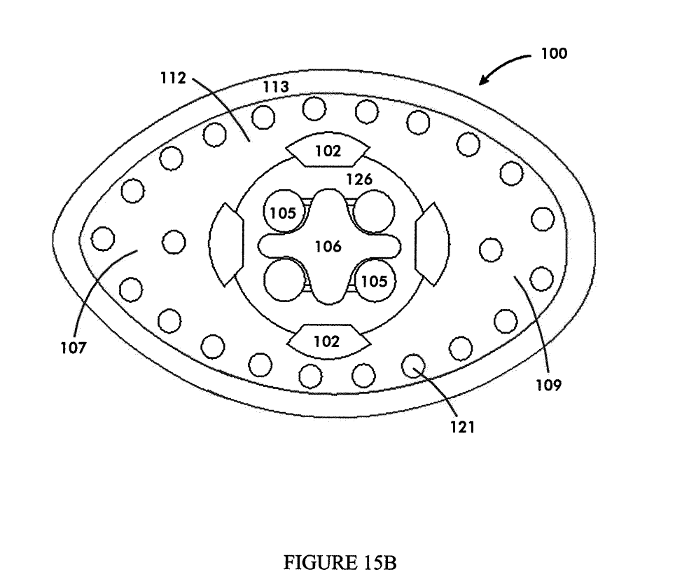

FIG. 15A and FIG. 15B illustrate the connection of the air-displacement mechanism 105 with the plurality of apertures and with an engine 106. The air-displacement mechanism 105 is operated by the engine 106, typically an electric motor is used. The engine 106 is not limited to the electric motor and any conventional engine utilizing a fossil fuel may be used to operate the air-displacement mechanism 105.

The air-thrust vehicle of the present disclosure does not have wheels, gearbox, suspensions and wing structures, thereby having reduced production cost. Moreover, the air-thrust vehicle of the present disclosure is movable on any type of surface and is capable of take-off and landing on unimproved airfields. The air-thrust vehicle of the present disclosure is easy to drive, has low fuel consumption due to reduced weight and has an effective balancing during the flight, thereby rendering the vehicle economical and safe.

Technical Advancements and Economic Significance.

The technical advantages of the system envisaged by the present disclosure include the realization of:
an air-thrust vehicle having a low production cost;
an air-thrust vehicle that does not require wings to fly;
an air-thrust vehicle that can operate on any category of airfield;
an air-thrust vehicle that is easy to drive; and
an air-thrust vehicle with reduced operational cost.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An air-thrust vehicle, said vehicle comprising:
a base;
an inverted saucer shaped body mounted on said base;
a plurality of sets of apertures defined at a plurality of pre-determined locations on said base and a plurality of sets of apertures defined at a plurality of pre-determined locations on said body;
a plurality of air-displacement mechanisms configured to draw air via pre-determined sets of apertures and force air through other pre-determined sets of apertures for providing lift for forward and backward movement and for providing horizontal pivoting of said vehicle on said base;
a plurality of ducts adapted to operatively connect said air-displacement mechanism to each aperture of said sets of apertures; and
an engine coupled to operate said air-displacement mechanism.

2. The air-thrust vehicle as claimed in claim 1, wherein said plurality of pre-determined locations are selected from the group consisting of front side, upper side, back side, front left side, rear left side, front right side, rear right side and bottom side.

3. The air-thrust vehicle as claimed in claim 1, wherein said air-displacement mechanism is selected from the group consisting of an axial compressor, a booster, a blower and a gas turbine.

4. The air-thrust vehicle as claimed in claim 1, wherein said air-displacement mechanism is configured to draw air via one or more of the plurality of sets of apertures defined at said upper side and force air via one or more of the plurality of sets of apertures defined at said bottom side for providing said lift to said air-thrust vehicle.

5. The air-thrust vehicle as claimed in claim 1, wherein said air-displacement mechanism is configured to draw air via one or more of the plurality of sets of apertures defined at said front side and force air via one or more of the plurality of apertures defined at said back side for providing said forward movement to said air-thrust vehicle.

6. The air-thrust vehicle as claimed in claim 1, wherein said air-displacement mechanism is configured to draw air via one or more of the plurality of sets of apertures defined at said front left side and force air via one or more of the plurality of sets of apertures defined at said rear left side for turning said air-thrust vehicle in an operative left direction.

7. The air-thrust vehicle as claimed in claim 1, wherein said air-displacement mechanism is further configured to draw air via sets of apertures defined at said front left side and said rear right side of said air-thrust vehicle and force the air via sets of apertures defined at said front right side and said rear left side for turning said air-thrust vehicle in an operative left direction.

8. The air-thrust vehicle as claimed in claim 1, wherein said air-displacement mechanism is further configured to draw air via one or more of the plurality of sets of apertures defined at said front right side and force air via one or more of the plurality of sets of apertures defined at said rear right side for turning said air-thrust vehicle in an operative right direction.

9. The air-thrust vehicle as claimed in claim 1, wherein said air-displacement mechanism is configured to draw air via sets of apertures defined at said front right side and said rear left side of said air-thrust vehicle and force the air via sets of apertures defined at said front left side and said rear right side for turning said air-thrust vehicle in an operative right direction.

10. The air-thrust vehicle as claimed in claim 1, wherein said air-displacement mechanism is configured to draw air via sets of apertures defined at said front left side and said rear left side of said air-thrust vehicle and force the air via sets of apertures defined at said front right side and said rear right side for moving said air-thrust vehicle in an operative left direction.

11. The air-thrust vehicle as claimed in claim 1, wherein said air-displacement mechanism is configured to draw air via sets of apertures defined at said front right side and said rear right side of said air-thrust vehicle and force the air via sets of apertures defined at said front left side and said rear left side for moving said air-thrust vehicle in an operative right direction.

12. The air-thrust vehicle as claimed in claim 1, wherein said air-displacement mechanism is configured to draw air via one or more of the plurality of sets of apertures defined at said back side and force air via one or more of the plurality of sets of apertures defined at said front side for providing said backward movement to said air-thrust vehicle.

13. The air-thrust vehicle as claimed in claim 1, wherein said sets of apertures are provided with an air filter.

14. The air-thrust vehicle as claimed in claim 1 further includes a rubber coating covering at least a portion of said body and said base.

15. The air-thrust vehicle as claimed in claim 1 further comprising a window glass disposed on at least a portion of said body.

16. The air-thrust vehicle as claimed in claim 1 having a center of gravity located at a centre point of said base.

17. The air-thrust vehicle as claimed in claim 1 further adapted to accommodate at least one passenger.
